(19) United States
(12) Patent Application Publication
(10) Pub. No.: US 2006/0208375 A1
(43) Pub. Date: Sep. 21, 2006

(54) Plant for the recycling of discard material

(76) Inventor: Zita Fuvesi, Budapest (HU)

Correspondence Address: STEVENS DAVIS MILLER & MOSHER, LLP, 1615 L STREET, NW, SUITE 850, WASHINGTON, DC, 20036, US

(21) Appl. No.: 10/182,054

(22) PCT Filed: Jun. 6, 2002
(86) PCT No.: PCT/CY02/00002

§ 371 Date: Dec. 24, 2002

(51) Int. Cl. B29B 17/00; B29C 47/92

(52) U.S. Cl. 264/37.32; 425/217

(57) ABSTRACT

Plant for the recycling of heterogeneous discard material of at least partly thermoplastic type, comprising a hot extrusion unit (18) in which the discard material is transformed into a fluid mix (20) suitable to be subjected to subsequent proceesing. The extrusion unit (18) comprises a substantially tubular body (27) defining an extrusion chamber and having an inner wall (32), inside which at least an extrusion screw (38) is housed. The distance (d) between the tips each extrusion screw (38) and the inner wall (32) is in the range of a few millimeters.

### FIELD OF THE INVENTION

The present invention refers to a plant for recycling discard material, of heterogeneous type and at least partly thermoplastic. The discard material can come for example from solid waste, both urban and industrial. In this plant the discard material is first reduced to small size granules, and transformed by means of hot extrusion into a fluid mix suitable to be subsequently shaped, for example by molding, into a determinate finished product. During extrusion, such mix is de-gassed gradually so as to eliminate any gases and vapors which may form due to the heating, and which can cause the formation of unwanted discontinuities in the finished product.

### BACKGROUND OF THE INVENTION

It is known a plant for recycling heterogeneous discard material, coming for example from the differentiated collection of waste and mainly containing thermoplastic materials, such as for example polyolefines. In this conventional plant, the discard material is first hot extruded by means of a plurality of extruders, to be transformed into a fluid mix, and then molded by compression, to be transformed into a finished artefact.

Each extruder comprises at least an extrusion cylinder, which is connected to a suction device which sucks in the gases and vapors which develop in the mix due, for example, to the thermal decomposition of the components present therein. To be more exact, suction is achieved by putting the chamber of the extrusion cylinder into depression and by making the gases and vapors pass through one or more small slits made on one wall of the extrusion cylinder.

In this conventional extruder, moreover, the space for the extrusion screws and the inner wall of the extrusion chamber is very small, in the range of a few tens of millimetres, so that the compact mix quickly advances towards the outlet of the extruder, thrust by the extrusion screws.

The conventional recycling plant has some disadvantages, however, which limit the use thereof and do not allow to efficiently work the mix emerging from the extruders. A first disadvantage is due to the suction of the gases and vapors which gives only a partial de-gassing of the gases and vapors with the risk that they are not completely eliminated during the extrusion step.

Another disadvantage is that there is a small space between the extrusion screws and the inner walls of the extrusion chamber in which they are housed. In this way, in fact, the mix is not mixed in the best possible way and it retains inside a lot of gases and vapors which, unable to be released or to condense totally during the extrusion step, cause the formation of a multitude of unwanted bubbles, which remain in the mix and do not allow to obtain a homogeneous and resistant final product.

The present Applicant has devised and embodied this invention to overcome this shortcoming of the state of the art and to obtain further advantages.

### SUMMARY OF THE INVENTION

The invention is set forth and characterized essentially in the main claims, while the dependent claims describe other innovative characteristics of the invention.

The purpose of the invention is to achieve a plant for recycling discard material and to perfect a relative recycling method, by means of which, starting from a heterogeneous discard material of at least partly thermoplastic type, it is possible to obtain an easily workable, fluid mix, to subsequently make a homogeneous and resistant final product without bubbles of gas inside.

In accordance with this purpose, a plant for recycling heterogeneous discard material of at least partly thermoplastic type comprises at least hot extrusion means of the discard material which are able to transform said discard material into a fluid mix suitable to be subsequently worked. To be more exact, said extrusion means comprise a tubular body which defines at least an extrusion chamber with an inner wall inside which at least one extrusion screw is housed.

According to one characteristic of the present invention, the space between the tip of each extrusion screw and the inner wall of the extrusion chamber is in the range of millimetres, advantageously from about 2 to about 5 mm, where the diameters of the screws are in the range of tens of centimetres.

Such a considerable space between the tips of the extrusion screws and the inner wall of the extrusion chamber gives the result that a part of the mix is not thrust continuously forwards, towards the outlet of the extruder, but stops against said wall and falls back, onto the adjacent threads of the same screws. In this way a very homogeneous mix is obtained, substantially without bubbles of gas or vapors.

Moreover, in accordance with another characteristic, the extrusion means comprise discharge means communicating with the outside and able to freely discharge all the gases or vapors produced during the extrusion operation.

The discard material to be treated can come, for example, from the differentiated collection of solid waste, either urban, domestic or industrial. It is preferable that such discard material be composed at least 50% of thermoplastic material, for example polyolefines, such as polyethylene (HDPE, LDPE), polypropylene, polyethylene terephthalate (PET), which act as a binder base during the extrusion step for the remaining discard components, which comprise, for example, paper, other types of plastics, for example of the thermosetting type, wood or metal substances, or otherwise.

The discard material is initially reduced to small-size fragments, such as granules, laminas, chip, pellets or otherwise, which can easily be mixed and melted by means of the extrusion means.

In one embodiment of the invention, the tubular body of the extrusion means is heated by means of heating elements, such as for example electric resistances, and the discharge means comprise at least a discharge aperture, advantageously made on the wall of the tubular body, in an intermediate position between a zone wherein the discard material is loaded and a zone from which the extruded fluid mix emerges. The tubular body is arranged, for example, substantially horizontal, and the discharge aperture is made in an upper zone of said wall, so as to allow the gases and vapors produced to be discharged upwards. The gases and vapors are thus discharged gradually and without being forced, since the discharge aperture is big enough, for example in the range of several square decimetres, to allow the gases and vapors to exit without difficulty.

Moreover, according to another characteristic of the present invention, the discharge aperture is made in a zone of the extrusion tubular body corresponding to the point of maximum heating of the fluid mix, so as to facilitate the exit of the gases precisely where the mix itself is hottest.

In one embodiment of the invention, said zone of maximum heating coincides with the central zone of the extrusion tubular body.

The present invention also concerns a method for the recycling of heterogeneous discard material of at least partly thermoplastic type, which comprises at least a step of hot extrusion in at least an extrusion tubular body, during which the discard material is transformed into a fluid mix. Said hot extrusion step comprises a sub-step wherein the gases and vapors are freely discharged to the outside of the extrusion tubular body, during which said gases and vapors are discharged freely and gradually.

### BRIEF DESCRIPTION OF THE DRAWINGS

These and other characteristics of the present invention will become apparent from the following description of a preferential form of embodiment, given as a non-restrictive example, with reference to the attached drawings wherein:

FIG. 1 is a diagram of the plant according to the invention;

FIG. 2 is a front view of a part of the plant in FIG. 1;

FIG. 3 is a section from A to A in FIG. 2.

### DETAILED DESCRIPTION OF A FORM OF PREFERENTIAL EMBODIMENT OF THE INVENTION

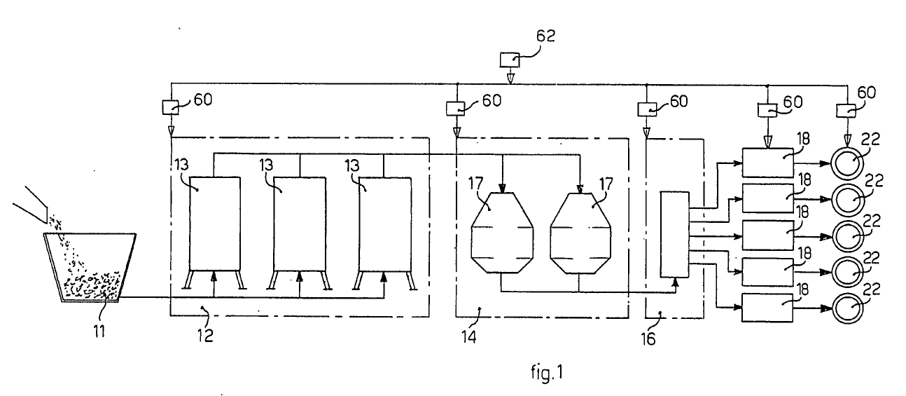

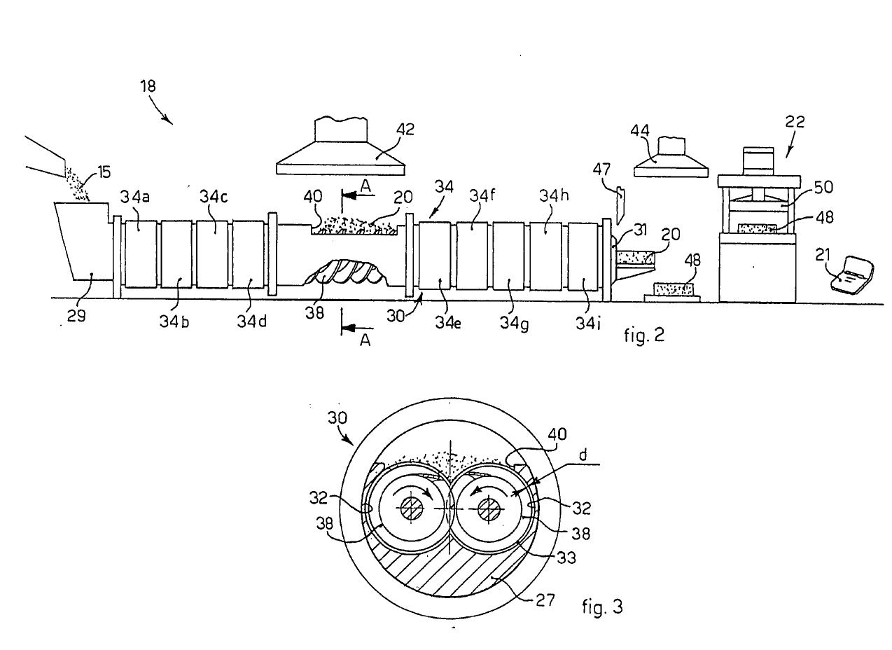

With reference to FIG. 1, a plant 10 for recycling discard material 11 based on heterogeneous thermoplastics essentially comprises a storage unit 12, consisting in this case of three silos 13 each containing a discard material 11 of different origin, a mixer unit 14, arranged downstream of the storage unit 12, consisting in this case of two mixers 17, a unit 16 to distribute the material and a plurality of extrusion stations 18, where the discard material 11 is fluidified and amalgamated to obtain a mix 20 (FIG. 2).

Moreover, downstream of each extrusion station 18, the plant 10 comprises a corresponding molding unit 22, where the mix 20, still fluid, is able to be pressed to obtain a determinate product 21, possibly susceptible to be subjected to subsequent processes, for example finishing.

The discard material 11 is advantageously reduced to granules, obtained for example in previous processing steps, through agglomeration or granulation. The granules are relatively small in size, with a maximum diameter of less than 1 cm, advantageously 7 mm.

Apart from heterogeneous thermoplastics, such as for example polyolefines, the discard material 11 can also contain other solid waste like paper, thermosetting plastics, metals, textile fibres or otherwise. The percentage of said other solid waste, with respect to the percentage of thermoplastics, is substantially irrelevant for the process according to the present invention, provided that the overall mixture 15, which is introduced into the extrusion stations 18 is at least 50% of heterogeneous thermoplastics. This is so that all the other solid wastes present which cannot be fused in said extrusion stations 18 can be easily bound and mixed.

To transport the discard material 11 contained in each silo 13, there is a screw system provided, of a conventional type and not shown in the drawings, arranged upstream of the two mixers 17.

The two mixers 17 are able to function alternately, so that while one is mixing the discard material 11, the other is discharging the mixture 15 towards the distribution unit 16, so as to ensure continuous feed to the individual extrusion stations 18.

Each extrusion station 18 comprises a hot extruder 30, consisting of a tubular body 27, substantially cylindrical in shape, inside which there is an extrusion chamber 33 defined by an inner wall 32. The extrusion chamber 33 is heated from the outside by means of a plurality of heating elements, for example electric resistances 34, adjacent to each other between an inlet 29, where the mixture 15 is loaded, and an outlet 31, where the mix 20 is made to exit. In this case there are nine electric resistances 34 (from 34a to 34i) and each of them is able to be heated to a determinate operating temperature, according to the position where it is located, along the tubular body 27. Normally the electric resistances 34 nearest the inlet 29 have a higher operating temperature, because they have to transfer high quantities of heat to the mixture 15 when it has just been loaded, and which normally enters at room temperature; the electric resistances 34 near the outlet 31, on the contrary, have lower operating temperatures, just sufficient to maintain the mixture 15 in a fluid state.

Inside the extrusion chamber 33 two extrusion screws 38 are assembled rotatable in reciprocally opposite directions. They have an inner diameter of a few decimetres and are able to knead the mixture 15 by compressing and mixing it at the same time, to transform it into the mix 20.

To be more exact, according to a characteristic of the present invention, the distance d between the tips of the extrusion screws 38 and the inner wall 32 of the extrusion chamber 33 is in the range of millimetres, for example from 1 to 10, and even more, advantageously from 2 to 5 mm.

In this way the two screws 38 of the tubular body 27 thrust the fluid mixture 15 at a relatively low speed, in the range of 80-110 rpm, so as to obtain an accurate mixing of the components of the mix inside the extruder 30, to facilitate, at the same time, the discharge of the gases and vapors, and to allow a part of the mix 20 to be “regurgitated” backwards, leapfrogging the threads of the screws 38, thanks to the large space between the tips of the screws 38 and the inner wall 32 of the extrusion chamber 33. According to another characteristic of the present invention, on the wall 32 of the tubular body 27, in a substantially central zone of the extrusion path, which in the example shown here corresponds to the intermediate zone between the fourth and the fifth electric resistance 34d and 34e, there is an aperture 40, for example substantially rectangular in shape, open upwards.

All the gases and vapors produced by the thermal degradation of the plastics and of the included materials, which develop as a consequence of the heating and the mechanical compression of the mixture 15, are able to freely exit from the extruder 30 through the aperture 40.

The vapors and gases are advantageously conveyed towards a chimney, of a conventional type and not shown in the drawings, by means of a suction hood 42, arranged above each extruder 30 in correspondence with the aperture 40. A corresponding filter device, of a conventional type and not shown in the drawings, is advantageously connected to the suction hood 42.

The aperture 40 allows to obtain a so-called “open-sky” suction of the vapors and gases and allows to obtain a natural, unforced de-gassing of the fluidified mixture 15, unlike what happens in the state of the art. This natural de-gassing facilitates a gradual and complete release of the gases and vapors.

At outlet from the tubular body 27 a second hood 44 is arranged able to further suck in the gases and vapors which develop in the second portion of the tubular body 27 and which emerge from the outlet aperture 31 when the mix 20 is made to exit.

According to another characteristic of the present invention, the temperature profile of the electric resistances 34 also encourages the natural de-gassing of the central zone of the tubular body 27, in correspondence with the aperture 40. To be more exact, the following operating temperatures are advantageously provided: 200° C. for the first electric resistance 34a; 250° C. for the second and third electric resistances 34b and 34c; 230° C. for the fourth electric resistance 34d; 250° C. for the fifth electric resistance 34e; 220° C. for the sixth electric resistance 34f and 180° C. for the seventh, eighth and ninth electric resistances 34g, 34h and 34i.

In this way the gases and vapors are sucked in in correspondence with the zone of maximum heating of the tubular body 27, in this case at the temperature of about 250° C., which corresponds to a real temperature of the fluid mixture 15, inside the tubular body 27, of about 150° C. This correspondence allows to optimize the expulsion of gases in the zone of maximum heating of the mixture 15.

The mix 20 emerging from the extrusion station 18 is cut into ingots 48 by a shears 47, of a conventional type. Each ingot 48 has a weight ocomprised between about 600 g and about 3000 g. Each ingot 48 is transferred to the molding unit 22, which in this case comprises one or more presses 50, where it is shaped and cooled into a desired shape, for example the body of a seat 21.

The plant 10 according to the present invention also comprises, connected to each of the processing units described heretofore, a corresponding peripheral electronic unit 60, to control and manage the relative method. All the peripheral units 60 are provided with a conventional type processor, for example PLC, and are managed by a central unit 62 which coordinates the entire plant 10.

To be more exact, the peripheral electronic unit 60 connected to the press 50 is also connected to a thickness detector, of a conventional type and not shown in the drawings, by means of which the presence of possible bubbles can be detected in the product 21 when its final thickness has been determined. If there are bubbles, the product 21 is discarded from the subsequent processing cycle and re-used for a new cycle of recovery.

It is clear however that modifications and/or additions of parts can be made to the plant 10 as described heretofore without departing from the field and scope of the present invention.

It is also clear that, although the present invention has been described with reference to specific examples, a person of skill shall certainly be able to achieve many other equivalent forms of plant for recycling discard material, all of which shall come within the field and scope of the present invention.

1. Plant for the recycling of heterogeneous discard material (11) comprising thermoplastic material, comprising: at least extrusion means (30) for the hot extrusion of said discard material (11) able to transform said discard material (11) into a fluid mix (20) able to be subjected to subsequent processing, wherein said extrusion means (30) comprise a substantially tubular body (27) defining at least an extrusion chamber (33) having an inner wall (32) inside which at least one extrusion screw (38) is housed, wherein the distance (d) between the tips of said at least one extrusion screw (38) and said inner wall (32) is in the range of millimeters.

2. Plant as in claim 1, wherein said distance (d) is between 2 and 5 mm.

3. Plant as in claim 1, wherein said extrusion means (30) are provided with discharge means (40) communicating with the outside, to freely discharge possible gases or vapors produced during the extrusion operation.

4. Plant as in claim 1, wherein said discharge means comprise at least a discharge aperture (40) made on said extrusion tubular body (27), in an intermediate position between a loading zone (29) wherein said discard material (11) is loaded and an outlet zone (31) from which said extruded fluid mix (20) exits.

5. Plant as in claim 4, wherein said at least one discharge aperture (40) is made in a substantially central zone of said tubular body (27).

6. Plant as in claim 4, wherein said tubular body (27) is arranged in a substantially horizontal position, wherein said at least one discharge aperture (40) is made in an upper zone of said tubular body (27).

7. Plant as in claim 1, wherein a plurality of heating elements (34), adjacent to each other, are arranged around said extrusion chamber (33) and each of said heating elements (34) is able to heat said fluid mix (20) to a determinate operating temperature.

8. Plant as in claim 4, wherein said at least one discharge aperture (40) is made between a first group of said heating elements (34a-34d), arranged towards said loading zone (29) of said discard material (11) in said tubular body (27), and a second group of said heating elements (34e-34i) arranged towards said outlet zone (31) of said fluid mix (20) from said tubular body (27).

9. Plant as in claim 7, wherein said at least one discharge aperture (40) is made in a zone of said tubular body (27) corresponding to the zone of maximum heating of said fluid mix (20).

10. Plant as in claim 1, wherein inside said extrusion chamber (33) two extrusion screws (38) are arranged, able to rotate in reciprocally opposite directions inside said tubular body (27) at a speed comprised between about 80 and 110 rpm, said speed being able to facilitate a gradual elimination of said gases and said vapors from said fluid mix (20) through said at least one aperture (40).

11. Plant as in claim 1, wherein said extrusion means comprise a plurality of extrusion stations (18), able to function simultaneously, and, upstream of said extrusion stations are provided storage means (13) and continuous feed means (17, 16) of said discard material (11) to each of said extrusion stations (18).

12. Plant as in claim 11, wherein directly downstream of each of said extrusion stations (18) are provided corresponding molding means (50) able to shape said fluid mix (20) through compression.

13. Method for the recycling of heterogeneous discard material (11) comprising thermoplastic material, comprising: at least a step of hot extrusion into at least a tubular body (27), during which said discard material (11) is transformed into a fluid mix (20), wherein said hot extrusion step comprises a sub-step of free discharge of possible gases and vapors to the outside of said tubular body (27) during which said gases and vapors are gradually discharged.
